(19) United States
(12) Patent Application Publication
(10) Pub. No.: US 2006/0007480 A1
(43) Pub. Date: Jan. 12, 2006

(54) Output end notifying method, output control apparatus, control program, and storing medium

(75) Inventor: Hidenori Yokokura, Kawasaki-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/171,351

(22) Filed: Jul. 1, 2005

(30) Foreign Application Priority Data
Jul. 6, 2004 (JP) 2004-199388

(51) Int. Cl. G06F 15/00

(52) U.S. Cl. 358/1.15

(57) ABSTRACT

It is an object that when specific application data is print-outputted, the user is not notified of a plurality of output end notifications of the number corresponding to the number of output copies but is efficiently notified that all jobs have been finished. When a plurality of same print jobs from the same transmitting source identifier are received, an output end notification of the print job other than the last-received print job among the plurality of same print jobs is not displayed to a display unit of a computer but an output end notification corresponding to the last-received print job is displayed to the display unit of the computer.

### BACKGROUND OF THE INVENTION

1. Field of the Invention

The invention relates to a mechanism for an end notification of a job which is executed in an output device for outputting on the basis of print data.

2. Related Background Art

In recent years, use of SOAP, XML, or the like having ease in programming, expandability, and flexibility has been widespread owing to the improvement of performance of a CPU and the improvement of a network speed. A print system in which an unspecified large number of users search for a print device via the Internet or Intranet and print by using the SOAP (Simple Object Access Protocol)/XML (eXtensible Markup Language) which has been progressed together with a Web technique has been proposed.

The SOAP/XML is also used in a printing apparatus in a local area network (LAN).

The SOAP denotes a protocol to access an object in a remote environment by using the XML. According to the XML, not only a fixed markup method like an HTML (Hyper Text Markup Language) but also a markup method that is unique to a document can be defined.

In such a print system, even in the print end notification, a function of notifying the job user or the administrator of the print end notification by using the SOAP/XML has also been developed. It is presumed that such a print system solution will be spread more and more in future.

Hitherto, as a method of enabling a session to be started from an external network side, there is a method called a static NAT (Network Address Translation) or static masquerade.

In a system including a host computer and a print device which are connected through a communication line irrespective of such a print system as mentioned above, a technique of notifying the host computer of the end of the printing in the printing device has been known.

However, among print applications, there is an application which, when the printing is performed for a number of print copies, transmits the same number of print jobs. If the printing is performed by using such an application, since a printing apparatus cannot distinguish whether or not the print jobs have been issued separately by the user, print end notifications of the number corresponding to the number of print copies are sent from the printing apparatus to the host computer.

Although it is sufficient that the user can recognize the end of all jobs whose printing has initially been requested, the host computer receives the print end notification from the printing apparatus each time the printing of one sheet is finished and is notified of events of the number corresponding to the number of print copies. Consequently, a print job management utility which is not easy to handle is obtained.

### SUMMARY OF THE INVENTION

The invention is, therefore, made in consideration of the drawbacks of the conventional technique as mentioned above and it is an object of the invention to solve troublesomeness of the user side without sending a plurality of output end notifications corresponding to the number of output copies to the user in the case where the specific application data mentioned above is printed and outputted.

To accomplish the above object, according to the invention, there is provided an output end notifying method in a system including an output device and a computer, comprising: receiving a print job including an identifier of a transmitting source; and controlling in such a manner that in the case where a plurality of same print jobs from the same transmitting source identifier are received in the receiving step, an end notification of the print job other than the print job which was received lastly among the plurality of same print jobs is not displayed to a display unit of the computer but an output end notification corresponding to the print job which was received lastly is displayed to the display unit of the computer.

According to the invention, since the user is not notified of the output end notifications of the number corresponding to the number of output copies, the troublesomeness of the user side can be eliminated.

Accordingly, the present invention is conceived as a response to the above-described disadvantages of the conventional art.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram showing a whole construction of a network system to which an output end notifying method and an output control apparatus according to the first embodiment are applied;

FIG. 2 is a diagram showing an internal construction of a printing apparatus (output device) in the first embodiment;

FIG. 3 is a diagram showing an example of application identification information in the printing apparatus in the first embodiment;

FIG. 4 is a diagram showing an example of a print management table in the printing apparatus in the first embodiment;

FIG. 5 is a diagram showing an example of packet data which is called “CreateJob” and is transmitted from a client (PC) to the printing apparatus by using the SOAP on the HTTP in the printing apparatus in the first embodiment;

FIG. 6 is a diagram showing an example of response packet data to packet data which is called “CreateJob” and is transmitted from the client to the printing apparatus by using the SOAP on the HTTP in the printing apparatus in the first embodiment;

FIG. 7 is a flowchart showing a flow of the operation of a general printing apparatus in the case where a host computer (client) of the printing apparatus in the first embodiment executes the printing;

FIG. 8 is a diagram showing an example of a print data transfer packet by an HTTP POST method of the printing apparatus in the first embodiment;

FIG. 9 is a diagram showing an example of an HTTP response packet showing that the reception of the print data of the printing apparatus in the first embodiment has normally been finished;

FIG. 10 is a diagram showing an example of an HTTP error response showing that the reception of the print data of the printing apparatus in the first embodiment has abnormally been finished;

FIG. 11 is a diagram showing an example of packet data which is called “Notification” and is transmitted from the printing apparatus to the client by using the SOAP on the HTTP in the printing apparatus in the first embodiment;

FIG. 12 is a flowchart showing the processing operation which is executed until a time-up end response is transmitted to a host computer after the printing apparatus in the first embodiment received the print data; and

FIG. 13 is a flowchart showing a flow of the operation of the printing apparatus for transmitting unique “Notification” to the host computer (client) of the printing apparatus in the first embodiment.

### DETAILED DESCRIPTION OF THE PREFERRED EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

Preferred embodiments of an output end notifying method, an output control apparatus, a control program, and a storing medium of the invention will now be described with reference to the drawings.

It is an essence of the invention that, for example, a discrimination is made to see if a job is a job to output same contents by a plurality of print sheets of or a job to output a plurality of different contents and, in the case of the job to output a plurality of different contents, an output end notification is sent to the user at a point of time when all print jobs are finished.

### First Embodiment

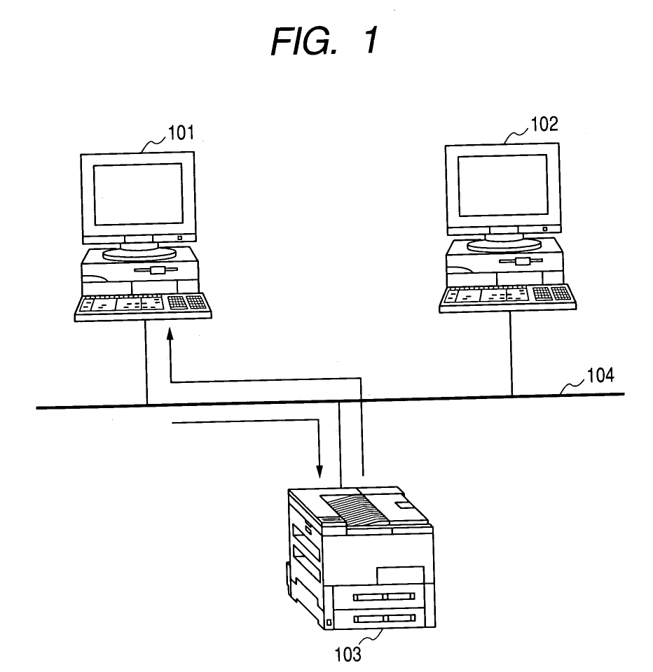

First, the first embodiment will be described with reference to FIGS. 1 to 13.

Although the embodiment will be described on the assumption that a network system having an output device and a computer is used, the invention is not limited only to such a network system but can be widely applied to an arbitrary system so long as it includes an output device and a computer.

FIG. 1 is a block diagram showing a whole construction of the network system to which an output end notifying method and an output control apparatus according to the embodiment are applied.

In FIG. 1, reference numerals 101 and 102 denote PCs (personal computers) as host computers; 103 a printing apparatus (or printer) as an output device; and 104 an LAN (local area network) as a communication line. The PCs 101 and 102 are connected to the LAN 104. Each of the PCs 101 and 102 can communicate with the output device 103 through the LAN 104 and execute network printing by transmitting a print job to the output device 103. When the printing is normally finished, a print end notification can be sent to the PC 101.

When a plurality of same print jobs are received from the same transmitting source identifier showing the transmitting source of the print job are received, an end notification of the print job other than the print job which was received lastly among the plurality of same print jobs is not displayed but an output end notification of the print output corresponding to the print job which was received lastly is displayed to display units of the PCs 101 and 102.

The transmitting source identifier and print job identifier such as print job name, file name, or the like are included in the print job. When the transmitting source identifier and the print job identifier receive a plurality of same print jobs, the end notification of the print job other than the last print job is not displayed but the output end notification of the print output corresponding to the last print job is displayed to the display units of the PCs 101 and 102.

When the print job formed on the basis of a predetermined application is not continuously received by a predetermined discriminating method, the output end notification of the print output of the last-received print job is displayed to display units of the PCs 101 and 102. As a predetermined discriminating method, for examples it is presumed to use a method whereby an inquiry to see if the printing is printing using the predetermined application and a response sequence are provided between the host computer and the printing apparatus.

The output device 103 receives an output data starting instruction and the output data from the PCs 101 and 102, and when the output is finished, notifies the PCs 101 and 102 of the end of the output. When the output device 103 does not receive the output starting instruction of the same print job identifier from the same transmitting source identifier for a predetermined time, the device 103 notifies the PCs 101 and 102 of the end of the output.

The user updates a numerical value showing the predetermined time and holds it into the output device 103.

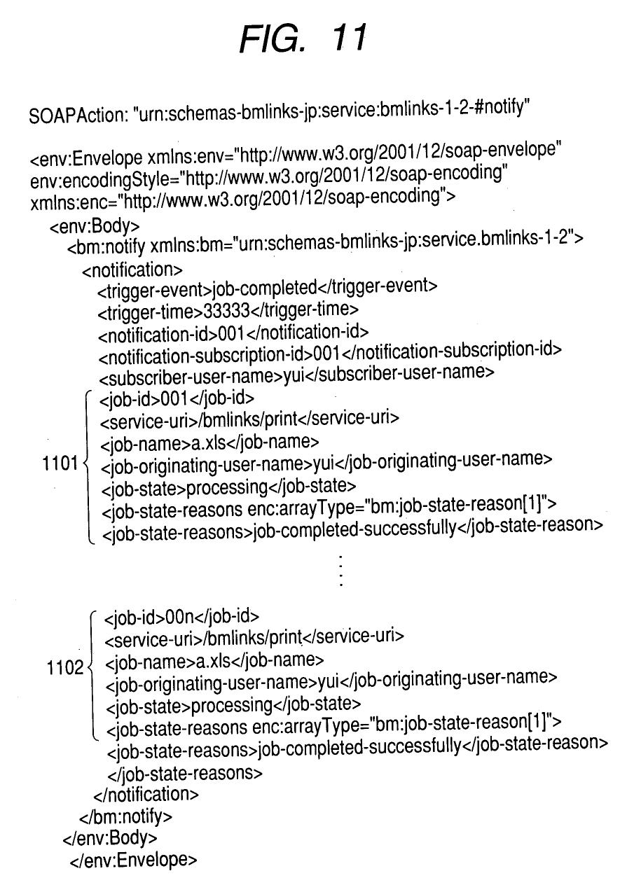

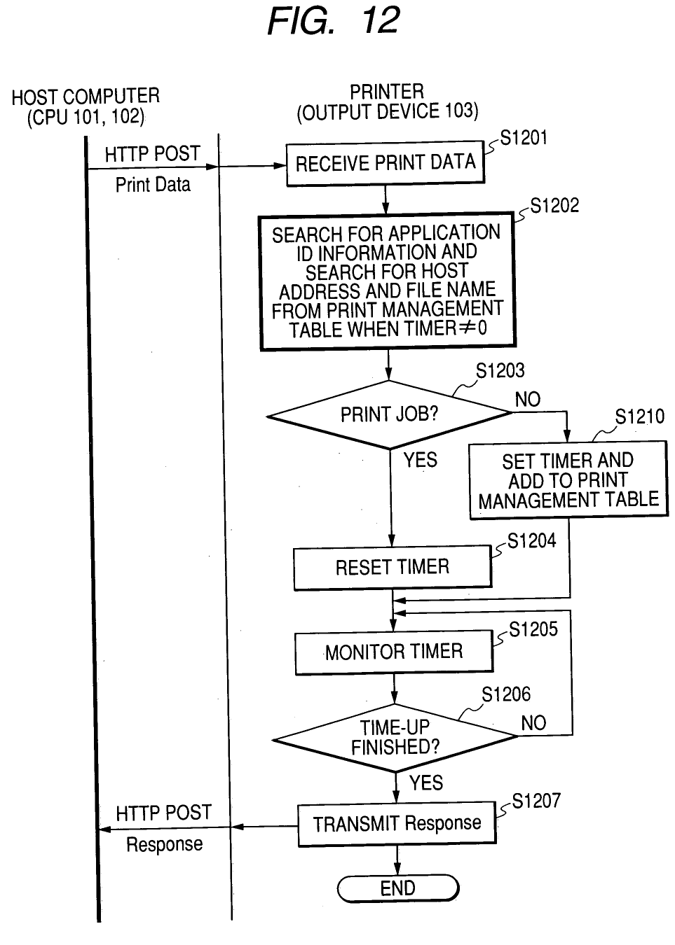

When the PCs 101 and 102 are notified of the end of the output, output end notification data which is formed at the time of the output end is notified every output data as a list as shown in FIG. 11, which will be explained hereinafter.

Whether or not the notifying method is selected by a discrimination result about whether or not an identifier indicative of the kind of application serving as a reference of the print job accompanied by a print job identifier is a specific kind of identifier is discriminated.

The user adds, deletes, or changes the identifier indicative of the kind of specific print job and holds it into the print device 103.

With respect to the discrimination about the same transmitting source identifier, whether or not the PCs are the same PCs 101 and 102 is discriminated on the basis of the address of the same transmitting source identifier or the user name.

Further, the transmitting source identifier is an identifier which can discriminate the PC 101 or 102 or a user identifier such as a name of login to the host computer in the PC 101 or 102 or the like. For example, the file name can be applied as a print job identifier.

As for the PCs 101 and 102 and the output device 103, the PCs and output devices of the numbers different from those shown in FIG. 1 can be also connected. A transmission destination of the print end notification is not limited to the PC 101 but the PC 101 can also transmit it to a desired notification destination and notify the administrator or the like. It is also possible to send the print end notification from the printing apparatus to the PC 101 through a print server (not shown in FIG. 1).

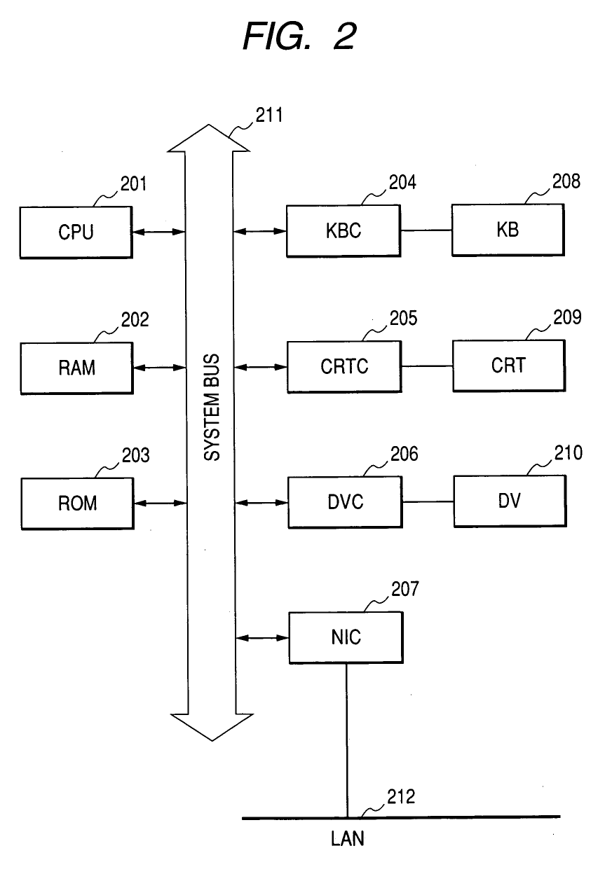

FIG. 2 is a block diagram showing an internal construction of the output device 103 in the embodiment. According to the internal construction of the output device 103, the embodiment is realized in such a form that a network control unit and a device (printer) control unit operate in one CPU (central processing unit).

In FIG. 2, reference numeral 201 denotes a CPU (central processing unit); 202 a RAM (random access memory); 203 a ROM (read only memory); 204 a KBC (keyboard controller); 205 a CRTC (display controller); 206 a DVC (output engine controller); 207 an NIC (network interface card); 208 a KB (keyboard); 209 a CRT (display); 210 a DV (output engine); 211 a system bus; and 212 an LAN (local area network).

The CPU 201 executes programs stored in the ROM 203 and integratedly controls each device connected to the system bus 211. When notifying that the output has been finished, the CPU 201 controls so that output end notification data formed every output data at the end of the output is notified as a list. The RAM 202 functions as a main memory, a work area, or the like of the CPU 201. Application identification (ID) information (extension or the like) showing from which application the print job has been formed in the PC 101 or 102 or the like, a print management table, a timer, print job information, and a job are stored in the RAM 202. A backup RAM to store system information is also constructed.

The keyboard controller 204 controls an instruction input from the keyboard 208. The display controller 205 controls the displaying operation of the display 209. The user can edit application information and a timer set value by using the keyboard 208 and the display 209. The output engine controller 206 controls the output engine 210 such as a printer printing unit or the like. The network interface card 207 bidirectionally transmits and receives data to/from another network apparatus or another PC (personal computer) through the LAN 212.

In the embodiment, the LAN 212 is substantially the same as the LAN 104 in FIG. 1.

The Application ID information, the print management table, the print job information, and the job can be stored in another storing device such as a hard disk or the like. A virtual keyboard can be also used by using a touch panel or the like comprising a liquid crystal panel in place of the keyboard 208.

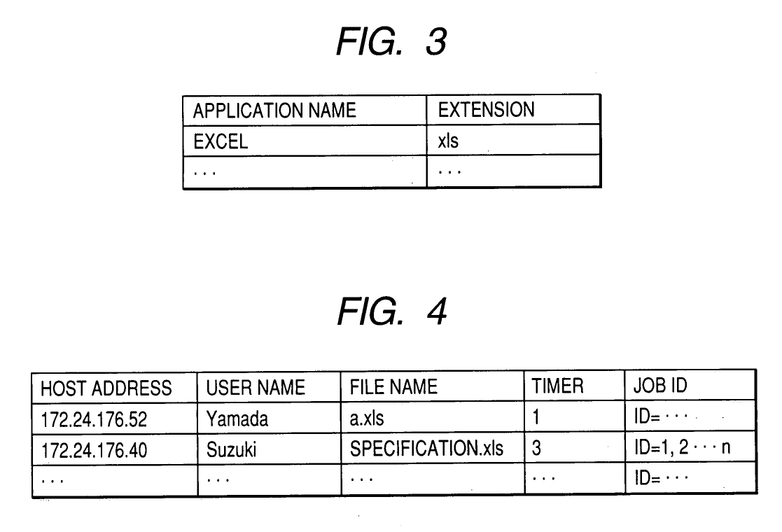

FIG. 3 is a diagram showing an example of the application ID information which is used in the output device 103 in the first embodiment. In the diagram, names of the applications installed in the PCs 101 and 102 are written in an application name column. As names of the applications, for example, “WORD (registered trademark)”, “EXCEL (registered trademark)”, and the like of Microsoft Corporation can be given. Since “EXCEL” is an application in which the jobs of the number corresponding to the number of output copies are sent when a plurality of sheets are designated as the number of output copies. Therefore, since “EXCEL” is an application in which a plurality of job end notifications are sent to the user, “EXCEL” is written as a name of the application in an application name column in FIG. 3. In FIG. 3, an extension associated with each application is written in an extension column. For example, there is “xls” as an extension.

The application ID information which is used in the output device 103 in the embodiment is not limited to that shown in FIG. 3 but format data based on a rule which has uniquely been determined can be also used so long as it is information by which the output device 103 can specify the kind of application serving as a base of the print job.

The user can change (update), add, or delete the foregoing application ID information by using input means such as a keyboard or the like on the output device 103 and display output means such as a liquid crystal panel or the like.

A keyword (for example, “_multi”) of the file name can be also held instead of the extension (for example, “xls”) as shown in FIG. 3.

FIG. 4 is a diagram showing an example of the print management table which is used in the output device 103 in the embodiment.

In FIG. 4, an IP (identifier) address of the PC (personal computer) which started the printing is written in a host address column. A login name (user identifier) of the user who executed the printing is written in a user name column. A name (in the case of FIG. 4, an application extension is included) of the file of the print job as a print job identifier is written in a file name column. A timer set value as a waiting time for the input of the next print job is written in a timer column. A job ID as an identifier to identify the print job which is generally added to each job when the job is received in the printing apparatus (output device 103) is written in a job ID column.

For example, a value of 1 second (default) or 3 seconds (default) is held as a timer set value which is written in a timer column. The timer set value is sequentially decremented by monitoring a timer.

In the invention, since a plurality of jobs inputted to the output device 103 at intervals within the timer set value are handled as a bundle of jobs, an identifier to identify each of the jobs which are handled as a bundle of jobs is provided and such an identifier is a job ID written in the job ID column.

As for the print management table shown in FIG. 4, whether or not the data are to be held is discriminated on the basis of the application ID information shown in FIG. 3.

Although the timer set value has been set to 1 second or 3 seconds in the embodiment, it can be set to another value. The user can change or add the timer set value by using the input means such as a keyboard or the like on the output device 103 and the display output means such as a liquid crystal panel or the like.

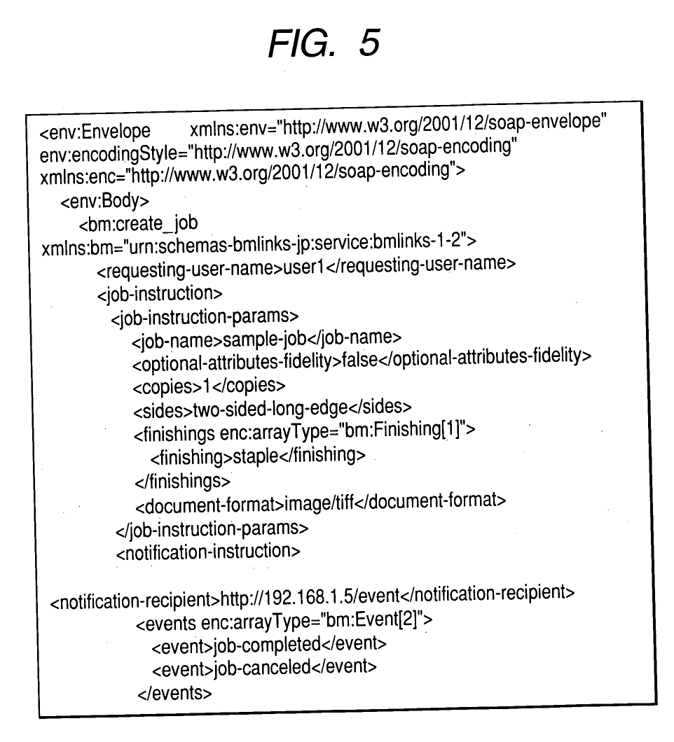

FIG. 5 is a diagram showing an example of packet data which is called “CreateJob” (hereinbelow, written as “CreateJob packet data”) and is transmitted from the client (PC 101, 102) to the output device 103 by using the SOAP on the HTTP (HyperText Transfer Protocol) as a protocol of an application level of the output device 103 in the embodiment.

The CreateJob packet data shown in FIG. 5 is described in an XML format. The CreateJob packet data is a command to instruct the output device 103 to start the job (printing) and information such as user name (<requesting-user-name> tag) of a requesting source, instruction (<job-instruction> tag) regarding the process of the job, and the like is written in the CreateJob packet data. The <job-instruction> tag includes: a <copies> tag to set the number of print copies; a <sides> tag to set the duplex printing; a <finishing> tag to set the finishing of the printing; and the like. On the basis of values set in those tags, the output device 103 executes the process of the job. Further, a <notification-instruction> tag can be also included as an option in the <job-instruction> tag. Notification information regarding the job is written in the <notification-instruction> tag.

In the example shown in FIG. 5, a <notification-recipient> tag to set the notification destination and an <event> tag to set the notifying conditions are written as notification information. On the basis of values set in those tags, the output device 103 executes an event transmitting process.

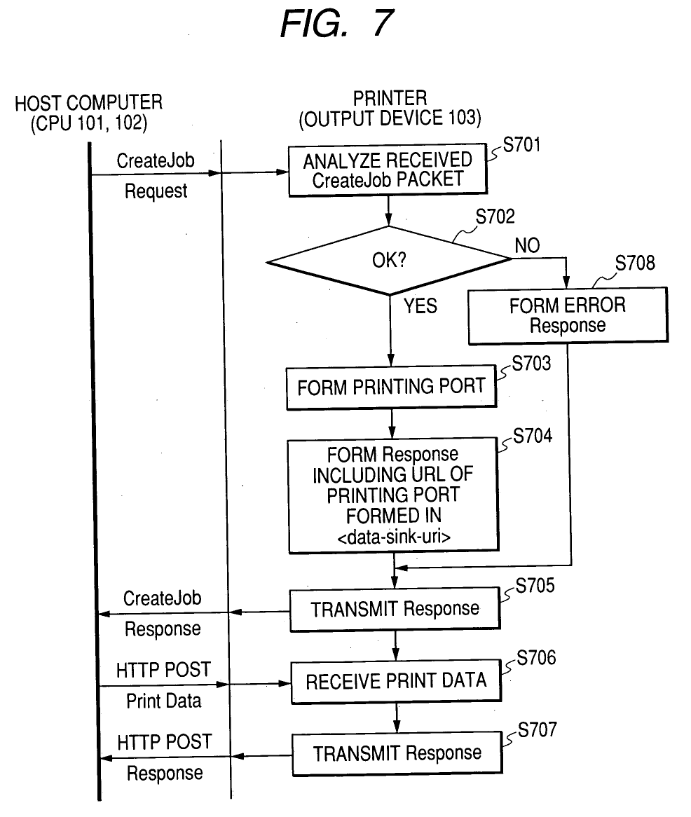

“CreateJob” shown in FIG. 5 is issued every job. With respect to a response transmission in step S707 in FIG. 7, which will be explained hereinafter, when a plurality of bundle of jobs are received in processes in FIG. 12, which will be explained hereinafter, such a response is issued from the printing apparatus to the host computer (PC 101).

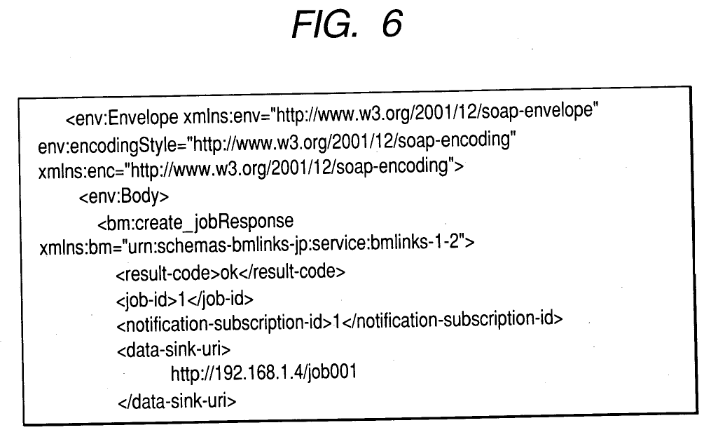

FIG. 6 is a diagram showing an example of response packet data (hereinbelow, written as “CreateJob response packet data”) for the CreateJob packet data shown in FIG. 5. The CreateJob response packet data is also described in the XML format in a manner similar to the CreateJob packet data shown in FIG. 5 and transmitted and received by using the SOAP on the HTTP in the embodiment. Information such as result code (<result-code> tag) for a CreateJob command, identifier of the formed job (<job-id> tag), URI (<data-sink-uri> tag) of a printing port, and the like is included in the CreateJob response packet data for the CreateJob packet data.

A URI “http://192.168.1.4/job001” is shown in the example shown in FIG. 6.

The operation of the printing apparatus (output device 103) which is controlled by the print control apparatus according to the embodiment will be described hereinbelow with reference to FIG. 7.

FIG. 7 is a flowchart showing a flow of the operation of the printing apparatus (output device 103) in the case where the host computer (PC 101 or 102) as a client makes a printing instruction.

First, for example, when the CreateJob packet data as shown in FIG. 6 is transmitted from the host computer 101 or 102 to the printing apparatus, the printing apparatus 103 which has received the CreateJob packet data analyzes XML data described in the CreateJob packet data in step S701. After that, step S702 follows and whether or not an error exists in an analysis result of the XML data in step S701 is discriminated. If it is determined that there is no error (OK), step S703 follows and a printing port for receiving the print data is formed. After that, step S704 follows and the XML data of a response to the CreateJob packet data is formed. A URI of the printing port formed to receive the print data in this instance is set as a value of the <data-sink-uri> tag. For example, the URI as shown in FIG. 6 is embedded in the XML data here.

After the forming process of the CreateJob response data is finished in step S704, step S705 follows and the CreateJob response data is transmitted to the host computer 101 or 102 by using the SOAP. After that, the host computer 101 or 102 transmits the print data to the printing apparatus 103 by using a POST method of the HTTP to the URI designated by the <data-sink-uri> tag.

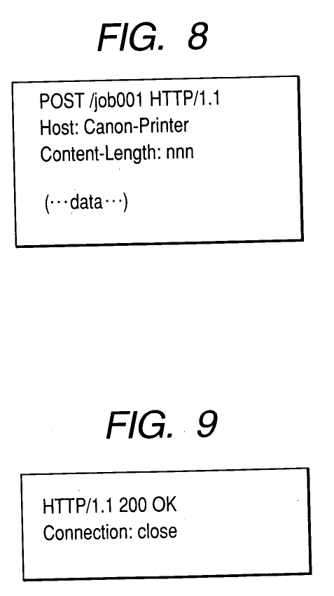

FIG. 8 is a diagram showing an example of a print data transfer packet which is transferred from the host computer 101 or 102 to the printing apparatus 103 by the HTTP POST method in step S706.

When the CreateJob response data is transmitted to the host computer 101 or 102 in step S705, the print data is sent from the host computer 101 or 102 to the printing apparatus 103. In step S706, the printing apparatus 103 receives the print data which was sent from the host computer 101 or 102 and reached the printing port. The print data which is received in step S706 corresponds to the print data which is received by the printing apparatus 103 in step S1201 in FIG. 12, which will be explained hereinafter.

While a proper process is being executed to the print data received in step S706, the printing apparatus 103 prints the processed data onto paper as a recording medium by the output engine 210.

When the reception of the print data is normally finished in step S706, the printing apparatus 103 transmits an HTTP response packet to the host computer 101 or 102 in step S707, deletes (closes) the printing port, and thereafter, finishes the printing operation.

FIG. 9 is a diagram showing an example of the HTTP response packet which is sent from the printing apparatus 103 to the host computer 101 or 102 in step S707.

If it is determined in step S702 that the error exists in the analysis result of the XML data in step S701, step S708 follows and an error response is formed. Thereafter, step S705 follows.

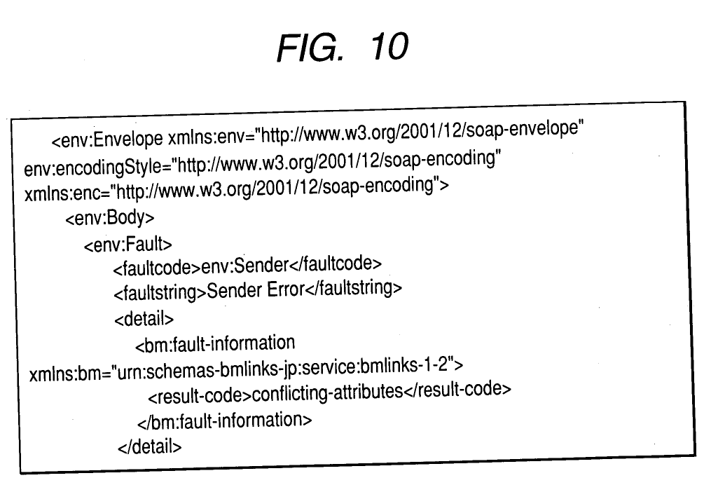

FIG. 10 is a diagram showing an example of the error response formed in step S708.

After the execution of steps S705 and S706, when the printing apparatus 103 transmits the error response to the host computer 101 or 102 in step S707, the host computer 101 or 102 finishes the processing operation without transmitting the print data.

FIG. 11 is a diagram showing an example of packet data which is called “Notification” (hereinafter, written as “Notification packet data”) and is transmitted from the output device (printing apparatus) 103 in the embodiment to the PC (host computer) 101 or 102 as a client by using the SOAP on the HTTP. The Notification packet data is described in the XML format.

The Notification packet data is a command which is sent to the client by using the end or cancellation of the job (printing) as an event and constructed by: an event (<trigger-event> tag) serving as a trigger of the event such as a job end or the like; a relative time (<trigger-timer> tag) from the timing of turn-on of a power source of a device in which the event has occurred; numerical values (<notification-id> tag) which are sequentially allocated in the event notification device; an id (<notification-subscription-id> tag) notified from the device at the time of registration of “Notification” which has been associated at the time of input of the job; a name of the user (<subscriber-user-name> tag) who registered “Notification”; a (<job-id> tag) indicative of the specific job; a URI (<server-uri> tag) which is making a job service; a job name (<job-name> tag) serving as a target of the event; a name of the user (<job-originating-user-name> tag) who sent the job; a state of the job (<job-state> tag) such as pending, job-completed, or the like; and detailed information of the job state (<job-state-reasons> tag) such as job-completed-successfully or the like.

Portions 1101 and 1102 in FIG. 11 are information showing the print end notification for a plurality of (n) jobs which are handled as a bundle and the user is notified of such information as a list. The information 1101 and 1102 is formed in the even that the end of the printing including print output medium ejection is confirmed for each print job in the printing apparatus.

Subsequently, the main section processing operation for discriminating, for example, whether the job is a job to print the same contents to a plurality of print sheets or a job to print a plurality of different contents in the output device 103 as a printing apparatus in the embodiment or the like will now be described with reference to FIG. 12.

FIG. 12 is a flowchart showing the processing operation which is executed until a time-up end response is transmitted to the PC 101 or 102 as a host computer after the printing apparatus (output device 103) in the embodiment received the print data.

In FIG. 12, it is an essence of the invention that only one management information in FIG. 4 (combination of the items shown by one line in FIG. 4) is formed for the job group of the same host and the same job name which are continuously inputted by the specific application. It is also possible to use a format in which management information is formed every job and the printing apparatus can recognize the individual jobs as one bundle of associated jobs

FIG. 12 differs from the flow of the ordinary flowchart with respect to points that the processes of steps S1201 to S1203 and step S1210 are executed independent of the processes of step S1204 and subsequent steps and that each time it is determined to be NO (negative) in step S1203, the processes of step S1204 and subsequent steps of each management information shown in FIG. 4 are executed in parallel.

In FIG. 12, the print request is already finished by the communication due to “CreateJob” shown in FIG. 7 and the print data is transmitted from the host computer 101 or 102 to the printing apparatus 103. First, in step S1201, the printing apparatus 103 has received the print data transfer packet by the HTTP POST method in FIG. 8 in a manner similar to step S706 in FIG. 7. It is also assumed that the output starting instruction is also included in the transfer packet of the print data.

Subsequently, in step S1202, the printing apparatus 103 extracts the IP address and the print file name from the print data received in step S1201 and searches for the print job in which an extension of the extracted print file name is equal to the application ID information registered in FIG. 3, the timer is not equal to 0 (≠ 0), and a host address (transmitting source identifier) and a file name (print job identifier) are the same as those of the contents described in the print management table shown in FIG. 4.

The extension (refer to FIG. 3) of the application as application ID information is included in the print file name. By recognizing the extension, it is possible to identify that the received print data has been issued from the host computer 101 or 102 on the basis of which application.

In step S1203, discrimination is made to see if the application ID information searched and extracted in step S1202 is the name having the extension registered in FIG. 3 and the print job of the same host address and file name as those described in the print management table (refer to FIG. 4) held in the printing apparatus 103 exists.

If it is determined that the print job whose name has the extension registered in the application ID information in FIG. 3 and which has the same host address and the same file name exists in the print management table, step S1204 follows. If NO, step S1210 follows.

In step S1204, the timer set value in the print management table (refer to FIG. 4) is reset to, for example, the default value of 3 seconds (the case of the user name “Suzuki”, the file name “specification.xls”, and the timer set value “3” in FIG. 4). In next step S1205, the timer set value written in the timer column in the print management table shown in FIG. 4 is monitored and decremented. Subsequently, whether or not the time-up has been finished (timer set value=0) is discriminated in step S1206. If it is determined that the time-up has been finished, step S1207 follows. If NO, the processing routine is returned to step S1205. Jumping to step S1207 denotes that the print job which does not coincide with the application ID information registered in FIG. 3 and which has the same host address and file name is not continuously received.

If the receiving process of the print data which is subsequently transmitted in step S1201 is executed during the processes of steps S1205 and S1206 (before the time-up), the processes of steps S1205 and S1206 are continued and the processes of steps S1202 and S1203 are executed in parallel therewith. If YES in step S1203 in this processing routine, an identifier peculiar to the job which was newly inputted is added to the item portion of the job ID of the corresponding record (line) in FIG. 4. The process of step S1204 is executed. The timer set value in the timer monitoring in step S1205 is cleared.

If NO in step S1203, the print management table is added in step S1210 (the lines in FIG. 4 are added) and the processes of steps S1205 and S1206 are continuously executed.

When the time-up is normally finished, in step S1207, the HTTP response packet as shown in FIG. 9 is transmitted to the host computer 101 or 102, the port for printing the print job of the same host address and file name as those of the last-received print job is deleted (closed), and the printing operation is finished. The printing port can be also deleted (closed) each time the reception of each of a plurality of jobs which are continuously received is finished.

In step S1210, as a new default of the timer, the timer set value of, for example, 3 seconds is set and the host address, user name, and file name are also registered into the print management table as shown in FIG. 4, and thereafter, step S1205 follows.

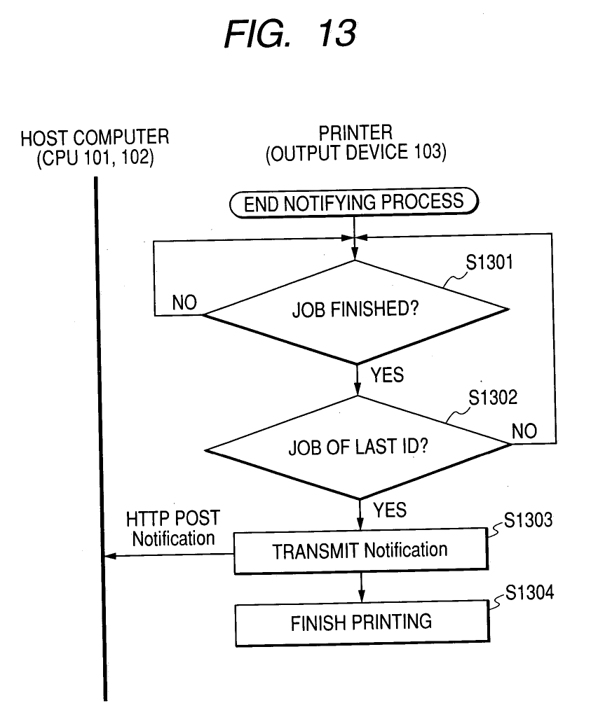

The Notification operation of the output device 103 as a printing apparatus according to the embodiment will now be described with reference to FIG. 13.

FIG. 13 is a flowchart showing the processing operation for notifying the user that the jobs have been finished at a point of time when all of the jobs are finished without notifying the user of a plurality of output end notifications of the number corresponding to the number of output copies.

In FIG. 13, first, whether or not the job has been finished is discriminated in step S1301 until it is finished. If it is decided that the job has been finished, step S1302 follows and whether or not the job which has been finished is the job of the last ID is discriminated. If it is determined that the job which has been finished is not the job of the last ID, the processing routine is returned to step S1301. If it is determined that the job which has been finished is the job of the last ID, the processing routine advances to step S1303.

The last lines in 1101 and 1102 in FIG. 11 indicate that the job of the last ID has been finished.

In step S1303, “Notification” in FIG. 11 is transmitted to the host computer 101 or 102 as a client, the host computer is notified that the print job has been finished, thereafter, the printing is finished, and the apparatus is returned to the idle state.

Although the default value of the timer has been set to 3 seconds, it can be set to any value other than 3 seconds or the user can also set it from the panel. Although the discrimination about the plurality of print copies has been made by checking whether or not the print job has the same host address and file name, the discrimination about the plurality of print copies can be also made by checking whether or not the print job has the same host address, user name, and file name. Further, the discrimination about the plurality of print copies can be also made by checking whether or not the print job has the same user name and file name. Moreover, an integration result in which the <notification> tags in FIG. 11 are written in a layout format can be also notified as a notification event.

The transmitting source identifier is not limited to the IP address of the host or the login user name but, for example, it is also possible to use an identifier (ID) of a print request unit of a plurality of sheets which is uniquely issued by the host computer (PC 101 or 102).

Although the notification of the end of the print job has been made by the process on the printing apparatus (the output device 103) side in the embodiment, it is also possible to construct in such a manner that the printing apparatus 103 notifies the host computer (PC 101 or 102) at random that all of the jobs have been finished, a print job management utility on the host computer side is allowed to make a discrimination, and the end notification of only the last job is displayed to the display unit.

More specifically speaking, if the print job management utility searches for the job ID (<job-id>) in the information in FIG. 11 and messages showing that the jobs of the number corresponding to the number of job IDs have been finished are displayed in a lump to the display unit, the print job management utility of higher ease of use can be realized.

### Other Embodiments

Although the preferred embodiments have been described above, the invention is not limited to the embodiments but can be also applied to an arbitrary construction so long as it can accomplish the functions shown by the scope of claims of the invention or the functions which the constructions of the embodiments have.

Naturally, the objects of the invention is accomplished by a method whereby a storing medium in which program codes of software to realize the functions of the foregoing embodiments have been stored is supplied to a system or an apparatus, a computer (or a CPU, an MPU, or the like) of the system or apparatus reads out the program codes stored in the storing medium, and executes them. In this case, the program codes themselves read out from the storing medium realize the novel functions of the invention. The storing medium in which the program codes have been stored and the programs construct the invention.

As a storing medium to supply the program codes, for example, a flexible disk, a hard disk, an optical disk, a magnetooptic disk, a CD-ROM, a CD-R, a magnetic tape, a non-volatile memory card, a ROM, or the like can be used.

Naturally, the invention incorporates not only the case where the computer executes the read-out program codes, so that the functions of the embodiments mentioned above are realized but also the case where the an OS (operating system) or the like which is operating on the computer executes a part or all of actual processes on the basis of instructions of the program codes and the functions of the embodiments mentioned above are realized by those processes.

Further, naturally, the invention also incorporates the case where the program codes read out from the storing medium are written into a memory provided for a function expanding board inserted in a computer or a function expanding unit connected to the computer, after that, a CPU or the like provided for the function expanding board or the function expanding unit executes a part or all of actual processes on the basis of instructions of the program codes and the functions of the embodiments mentioned above are realized by those processes.

As described above, in the case where a plurality of print jobs of the same name are received from the same transmitting source identifier, the end notification of the print job other than the print job which was received lastly among the plurality of same print jobs is not displayed to the display unit of the host computer but the output end notification corresponding to the print job which was received lastly is displayed to the display units of the host computer, so that the print job management utility of high ease of use can be provided.

This application claims priority from Japanese Patent Application No. 2004-199388 filed Jul. 6, 2004, which is hereby incorporated by reference herein.

What is claimed is:

1. An output end notifying method in a system including an output device and a computer, comprising:
receiving a print job including an identifier of a transmitting source; and
controlling in such a manner that in the case where a plurality of same print jobs from the same transmitting source identifier are received in said receiving step, an end notification of the print job other than the print job which was received lastly among said plurality of same print jobs is not displayed to a display unit of said computer but an output end notification corresponding to the print job which was received lastly is displayed to the display unit of said computer.

2. A method according to claim 1, wherein said transmitting source identifier and a print job identifier are included in said print job, and in said control step, the control is made in such a manner that in the case where the transmitting source identifier and the print job identifier receive said plurality of same print jobs in said receiving step, the end notification of the print job other than the last print job is not displayed to the display unit of said computer but the output end notification of the last print job is displayed to the display unit of said computer.

3. A method according to claim 1, wherein if it is determined by a predetermined discriminating method that the print jobs formed on the basis of a predetermined application are not continuously received in said receiving step, the output end notification of the print output of the print job which was received lastly is displayed to the display unit of said computer.

4. An output end notifying method in a system including an output device and a computer, comprising:
allowing said output device to receive an output data starting instruction and output data from said computer and notifying said computer that an output has been finished in accordance with the end of the output; and
controlling so as to notify said computer that the output has been finished in the case where said output device did not receive an output starting instruction of a same print job identifier from a same transmitting source identifier for a predetermined time.

5. A method according to claim 4, wherein in said controlling step, the control is made in such a manner that when it is notified that the output has been finished, notification data which is formed at the time of the end of the output is notified as a list every output data.

6. A method according to claim 4, further comprising a first discriminating step of discriminating whether or not a notifying method according to said notifying step is selected by discriminating whether or not an identifier indicative of a kind of application serving as a base of the print job accompanied by said print job identifier is a specific kind of identifier.

7. A method according to claim 6, wherein the user adds, deletes, or updates the identifier indicative of said specific kind of print job and holds it into said output device.

8. A method according to claim 4, further comprising a second discriminating step of discriminating about the same transmitting source identifier, and
wherein in said second discriminating step, a discrimination about the same computer is made on the basis of an address of said same transmitting source identifier or a user name.

9. A method according to claim 4, wherein the user updates a numerical value showing said predetermined time and holds it into said output device.

10. A method according to claim 4, wherein said transmitting source identifier is an identifier which can identify the computer or a user identifier in said computer and said print job identifier is a file name.

11. An output control apparatus which can communicate with a computer, comprising:
a receiver adapted to receive a print job including an identifier of a transmitting source; and
a controller adapted to control in such a manner that in the case where a plurality of same print jobs from the same transmitting source identifier are received by said receiver, an end notification of the print job other than the print job which was received lastly among said plurality of same print jobs is not displayed to a display unit of said computer but an output end notification corresponding to the print job which was received lastly is displayed to the display unit of said computer.

12. An apparatus according to claim 11, wherein said transmitting source identifier and a print job identifier are included in said print job, and said controller makes the control in such a manner that in the case where the transmitting source identifier and the print job identifier receive said plurality of same print jobs by said receiver, the end notification of the print job other than the last print job is not displayed to the display unit of said computer but the output end notification of the last print job is displayed to the display unit of said computer.

13. An apparatus according to claim 11, wherein if it is determined by a predetermined discriminating method that the print jobs formed on the basis of a predetermined application are not continuously received by said receiver, the output end notification of the print output of the print job which was received lastly is displayed to the display unit of said computer.

14. An output control apparatus which can communicate with a computer, comprising:
a notifying unit adapted to allow an output device to receive an output data starting instruction and output data from said computer and adapted to notify said computer that an output has been finished in accordance with the end of the output; and
a controller adapted to control so as to notify said computer that the output has been finished in the case where said output device did not receive an output starting instruction of a same print job identifier from a same transmitting source identifier for a predetermined time.

15. An apparatus according to claim 14, wherein when it is notified that the output has been finished, said controller makes the control in such a manner that notification data which is formed at the time of the end of the output is notified as a list every output data.

16. An apparatus according to claim 14, further comprising a first discriminator adapted to discriminate whether or not a notifying method according to said notifying unit is selected by discriminating whether or not an identifier indicative of a kind of application serving as a base of the print job accompanied by said print job identifier is a specific kind of identifier.

17. An apparatus according to claim 16, wherein the user adds, deletes, or updates the identifier indicative of said specific kind of print job and holds it into said output device.

18. An apparatus according to claim 14, further comprising a second discriminator adapted to discriminate about the same transmitting source identifier, and
wherein said second discriminator discriminates about the same computer on the basis of an address of said same transmitting source identifier or a user name.

19. An apparatus according to claim 14, wherein the user updates a numerical value showing said predetermined time and holds it into said output device.

20. An apparatus according to claim 14, wherein said transmitting source identifier is an identifier which can identify the computer or a user identifier in said computer and said print job identifier is a file name.

21. A program for allowing a computer to execute an output end notifying method in an output device which can communicate with a computer,
wherein said method comprises:
allowing said output device to receive an output data starting instruction and output data from said computer and notifying said computer that an output has been finished in accordance with the end of the output; and
controlling so as to notify said computer that the output has been finished in the case where said output device did not receive an output starting instruction of a same print job identifier from a same transmitting source identifier for a predetermined time.
